(19) United States
(12) Patent Application Publication
(10) Pub. No.: US 2019/0297270 A1
(43) Pub. Date: Sep. 26, 2019

(54) IMAGE - CAPTURING APPARATUS

(71) Applicant: NIKON CORPORATION, Tokyo (JP)

(72) Inventors: Marie SHIMOYAMA, Tokyo (JP); Daisaku KOMIYA, Tokyo (JP); Takashi SHIONOYA, Koganei-shi (JP)

(73) Assignee: NIKON CORPORATION, Tokyo (JP)

(21) Appl. No.: 16/329,882

(22) PCT Filed: Sep. 19, 2017
(86) PCT No.: PCT/JP2017/033740

§ 371 Date: Mar. 1, 2019

(30) Foreign Application Priority Data
Sep. 29, 2016 (JP) 2016-192253

(51) Int. Cl. H04N 5/232; G02B 3/00; G02B 7/09; G02B 7/28; G02B 7/38; G03B 13/36

(52) U.S. Cl. CPC H04N 5/232125; H04N 5/23296; H04N 5/23299; H04N 5/23218; G03B 13/36; G02B 7/09; G02B 7/282; G02B 7/38; G02B 3/0006

(57) ABSTRACT

An image-capturing apparatus includes: an optical system having a variable power function; microlenses; an image sensor having pixel groups each including pixels, receiving light having passed through the optical system and the microlenses at the pixel groups, and outputting a signal based on the received light; and an image processing unit generating an image focused on one point of an object among objects at different positions in an optical axis direction, based on the sensor signal output. If a range length in the optical axis direction specified by a focal length in which the optical system focuses on one point of a target object is longer than a length based on the object, the unit generates a first image focused on one point in the range, and if the range length is smaller, the unit generates a second image focused on one point outside and one within the range.

### TECHNICAL FIELD

The present invention relates to an image-capturing apparatus.

### BACKGROUND ART

A refocus camera that generates an image at any image plane by refocus processing is known (see PTL1, for example). An image generated by the refocusing processing may include a subject in focus and a subject out of focus, as in a normal photographed image.

### CITATION LIST

### Patent Literature

PTL1: Japanese Laid-Open Patent Publication No. 2015-32948

### SUMMARY OF INVENTION

According to the 1st aspect of the present invention, an image-capturing apparatus comprises: an optical system having a variable power function; a plurality of microlenses; an image sensor having a plurality of pixel groups each including a plurality of pixels, receiving light having passed through the optical system and the microlenses respectively at the pixel groups, and outputting a signal based on the received light; and an image processing unit that generates an image focused on one point of at least one object among a plurality of objects located at different positions in an optical axis direction, based on the signal output by the image sensor, wherein: if a length of a range in the optical axis direction specified by a focal length in a case where the optical system focuses on one point of a target object is longer than a length based on the target object, the image processing unit generates a first image focused on one point in the range, and if the length of the range is smaller than the length based on the target object, the image processing unit generates a second image focused on one point outside the range and one point within the range.

According to the 2nd aspect of the present invention, an image-capturing apparatus comprises: an optical system having a variable power function; a plurality of microlenses; an image sensor having a plurality of pixel groups each including a plurality of pixels, receiving light having passed through the optical system and the microlenses respectively at the pixel groups, and outputting a signal based on the received light; and an image processing unit that generates an image focused on one point of at least one object among a plurality of objects located at different positions in an optical axis of the optical system, based on the signal output by the image sensor, wherein: if the entire target object is included within the range in the optical axis direction specified by the focal length in a case where the optical system focuses on one point of the target object, the image processing unit generates a first image focused on one point within the range, and if at least a part of the target object is included within the outside of the range, the image processing unit generates a second image focused on one point outside the range and one point within the range.

According to the 3rd aspect of the present invention, an image-capturing apparatus comprises: an optical system having a variable power function; a plurality of microlenses; an image sensor having a plurality of pixel groups each including a plurality of pixels, receiving light having passed through the optical system and the microlenses, and outputting a signal based on the received light; and an image processing unit that generates an image focused on one point of at least one object among a plurality of objects located at different positions in an optical axis of the optical system, based on the signal output by the image sensor, wherein: if the target object is located within the depth of field, the image processing unit generates a first image focused on one point within the depth of field, and if a part of the target object is outside the depth of field, the image processing unit generates a second image focused on one point of the target object located outside the depth of field and one point of the target object located within the depth of field.

According to the 4th aspect of the present invention, an image-capturing apparatus comprises: an optical system having a variable power function; a plurality of microlenses; an image sensor having a plurality of pixel groups each including a plurality of pixels, receiving light having passed through the optical system and the microlenses respectively at the pixel groups, and outputting a signal based on the received light; and an image processing unit that generates an image focused on one point of at least one object among a plurality of objects located at different positions in an optical axis of the optical system, based on the signal output by the image sensor, wherein: if it is determined that the entire target object is in focus, the image processing unit generates a first image that is determined to be in focus on the target object, and if it is determined that a part of the target object is out of focus, the image processing unit generates a second image that is determined to be in focus on the entire target object.

According to the 5th aspect of the present invention, an image-capturing apparatus comprises: an optical system; a plurality of microlenses; an image sensor having a plurality of pixel groups each including a plurality of pixels, receiving light having originated from a subject and having passed through the optical system and the microlenses respectively at the pixel groups, and outputting a signal based on the received light; and an image processing unit that generates image data based on the signal output from the image sensor, wherein: if it is determined that one end or another end of the subject in the optical axis direction is not included within the depth of field, the image processing unit generates third image data based on first image data having the one end included within a depth of field thereof and second image data having the other end included within a depth of field thereof.

### BRIEF DESCRIPTION OF DRAWINGS

FIG. 1 schematically shows a configuration of an image-capturing system.

FIG. 2 is a block diagram schematically showing a configuration of the image-capturing apparatus.

FIG. 3 is a perspective view schematically showing a configuration of an image-capturing unit.

FIG. 4 is a view for explaining a principle of refocusing processing.

FIG. 5 schematically shows a change in focusing range by image synthesis.

FIG. 6 is a top view schematically showing an angle of view of the image-capturing apparatus.

FIG. 7 shows an example of an image.

FIG. 8 is a flowchart showing an operation of the image-capturing apparatus.

FIG. 9 is a block diagram schematically showing a configuration of the image-capturing apparatus.

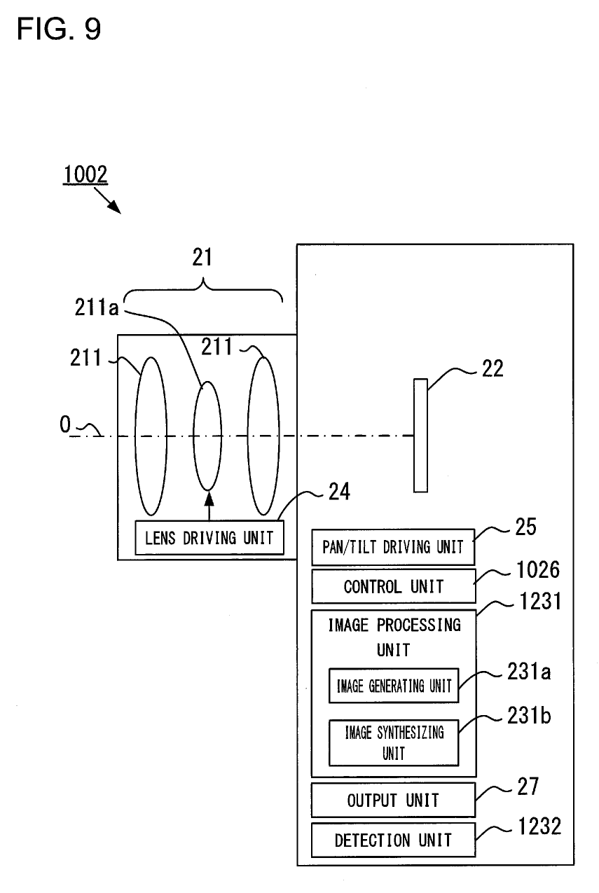

FIG. 10 is a flowchart showing an operation of the image-capturing apparatus.

FIG. 11 is a flowchart showing an operation of the image-capturing apparatus.

FIG. 12 is a top view illustrating a relationship between a subject of interest and a depth of field.

### DESCRIPTION OF EMBODIMENTS

### First Embodiment

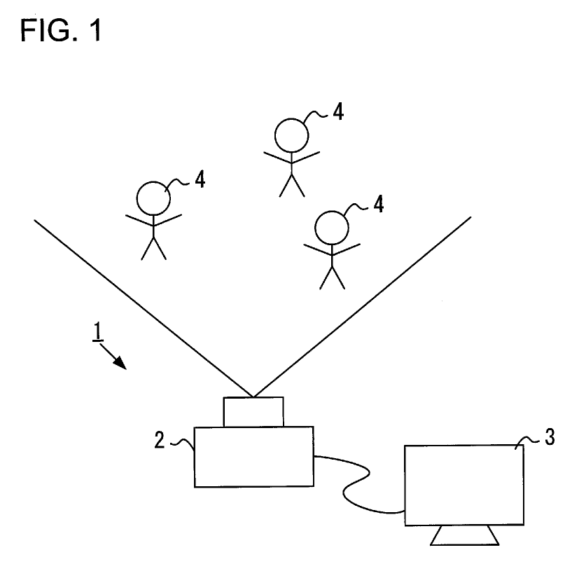

FIG. 1 is a view schematically showing a configuration of an image-capturing system using the image-capturing apparatus according to a first embodiment. The image-capturing system 1 is a system that monitors a predetermined area to be monitored (for example, a river, a port, an airport, a city, etc.). The image-capturing system 1 includes an image-capturing apparatus 2 and a display apparatus 3.

The image-capturing apparatus 2 is configured to be able to capture an image of a wide range including one or more monitor targets 4. The monitor targets as used herein include, for example, an object to be monitored such as a ship, a crew on board, a cargo, an airplane, a person, a bird and the like. The image-capturing apparatus 2 outputs images (described later) to the display apparatus 3 at a predetermined period (for example, 1/30 second). The display apparatus 3 displays the images output by the image-capturing apparatus 2, for example, on a liquid crystal panel. An operator who performs monitoring views a display screen of the display apparatus 3 to perform monitoring tasks.

The image-capturing apparatus 2 is configured to be able to perform operations of pan, tilt, zoom, and the like. In response to an operator operating an operating member such as a touch panel (not shown) provided in the display apparatus 3, the image-capturing apparatus 2 performs various operations such as pan, tilt, and zoom. This allows the operator to monitor a wide area in detail.

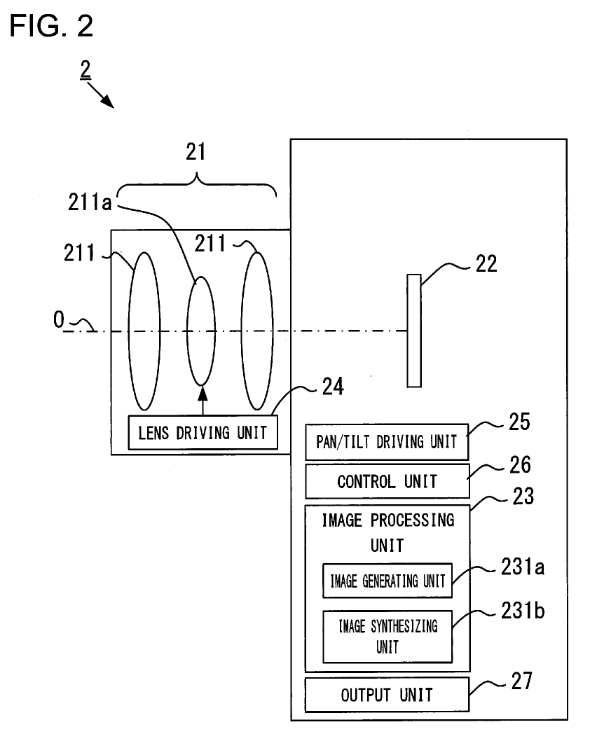

FIG. 2 is a block diagram schematically showing a configuration of the image-capturing apparatus 2. The image-capturing apparatus 2 includes an image-capturing optical system 21, an image-capturing unit 22, an image processing unit 23, a lens driving unit 24, a pan/tilt driving unit 25, a control unit 26, and an output unit 27.

The image-capturing optical system 21 forms a subject image onto the image-capturing unit 22. The image-capturing optical system 21 has a plurality of lenses 211. The plurality of lenses 211 includes a variable power (zoom) lens 211a capable of adjusting a focal length of the image-capturing optical system 21. That is, the image-capturing optical system 21 has a zoom function.

The image-capturing unit 22 has a microlens array 221 and a light receiving element array 222. A configuration of the image-capturing unit 22 will be described in detail later.

The image processing unit 23 includes an image generating unit 231a and an image synthesizing unit 231b. The image generating unit 231a executes image processing (described later) on a light receiving signal output from the light receiving element array 222 to generate a first image which is an image at any image plane. Although details will be described later, the image generating unit 231a can generate images at a plurality of image planes from light receiving signals output by the light receiving element array 222 in one light reception session. The image synthesizing unit 231b executes image processing (described later) on the images at the plurality of image planes generated by the image generating unit 231a to generate a second image having a deeper depth of field (i.e., having a wider focused range) than that of each of the images at the plurality of image planes. The depth of field as used hereinafter is defined as a range considered to be in focus (a range in which a subject is not considered to be blurred). That is, it is not limited to a depth of field calculated by a formula. For example, it may be a range obtained by adding or removing a predetermined range to/from a depth of field calculated by a formula. When a depth of field calculated by a formula is a range of 5 m with reference to the focusing position, a range of 7 m obtained by adding a predetermined range (for example, 1 m) in front of and behind the calculated depth of field may be considered as a depth of field. A range of 4 m obtained by removing front and rear parts having a predetermined range (for example, 0.5 m each) from the calculated depth of field may be considered as a depth of field. The predetermined range may be a predetermined numerical value or may be changed according to the size and orientation of a subject of interest 4b described later. The depth of field (a range considered to be in focus, a range in which a subject is not considered to be blurred) may also be detected from the image. For example, an image processing technique can be used to detect a subject in focus and a subject out of focus.

The lens driving unit 24 drives the plurality of lenses 211 in an optical axis O direction by an actuator (not shown). For example, this driving causes a variable power lens 211a to be driven so that a focal length of the image-capturing optical system 21 can be changed for zooming.

The pan/tilt driving unit 25 changes an orientation of the image-capturing apparatus 2 in a left-right direction and an up-down direction by an actuator (not shown). In other words, the pan/tilt driving unit 25 changes a yaw angle and a pitch angle of the image-capturing apparatus 2.

The control unit 26 includes a CPU (not shown) and its peripheral circuits. The control unit 26 controls units of the image-capturing apparatus 2 by reading and executing predetermined control program from a ROM (not shown). Each of these functional units is implemented as software by the above-described predetermined control program. Note that each of these functional units may be implemented by an electronic circuit or the like.

The output unit 27 outputs the image generated by the image processing unit 23 to the display apparatus 3.

Description of Image-Capturing Unit 22

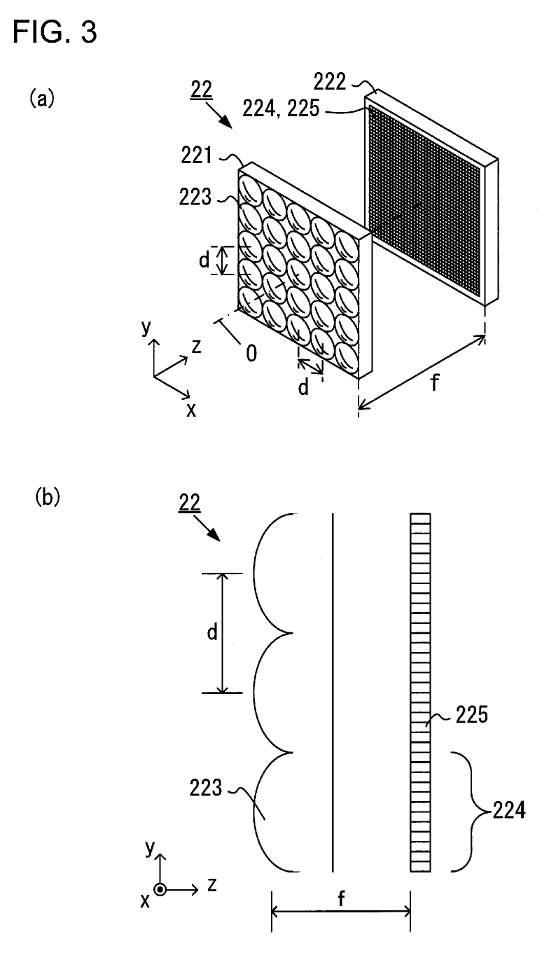

FIG. 3(a) is a perspective view schematically showing a configuration of the image-capturing unit 22 and FIG. 3(b) is a cross-sectional view schematically showing the configuration of the image-capturing unit 22. The microlens array 221 receives light flux that has passed through the image-capturing optical system 21 (FIG. 2). The microlens array 221 has a plurality of microlenses 223 arranged two-dimensionally with a pitch d. The microlens 223 is a convex lens having a shape that is convex toward the image-capturing optical system 21.

The light receiving element array 222 has a plurality of light receiving elements 225 arranged two-dimensionally. The light receiving element array 222 is arranged so that a light receiving plane coincides with a focal position of the microlens 223. In other words, a distance between a front-side main plane of the microlens 223 and the light receiving plane of the light receiving element array 222 is equal to a focal length f of the microlens 223. Note that in FIG. 3, a spacing between the microlens array 221 and the light receiving element array 222 is shown to be wider than it actually is.

In FIG. 3, light from each individual part of a subject is incident on each microlens 223 of the microlens array 221. The light from the subject incident on the microlens array 221 is divided into a plurality of pieces by the microlens 223 that constitutes the microlens array 221. Light having passed through each microlens 223 is incident on a plurality of light receiving elements 225 arranged behind the corresponding microlens 223 (in positive Z-axis direction). In the following description, the plurality of light receiving elements 225 corresponding to one microlens 223 are referred to as a light receiving element group 224. That is, the light having passed through one microlens 223 is incident on one light receiving element group 224 corresponding to the microlens 223. Each light receiving element 225 included in the light receiving element group 224 receives light which originates from a part of a subject and which has passed through each individual region of the image-capturing optical system 21.

An incident direction of light incident on each light receiving element 225 is determined by a position of the light receiving element 225. A positional relationship between the microlens 223 and each light receiving element 225 included in the light receiving element group 224 behind the microlens 223 is known as design information. That is, an incident direction of a light beam incident on each light receiving element 225 through the microlens 223 is known. Therefore, a light receiving output of the light receiving element 225 means an intensity (light beam information) of light from a predetermined incident direction corresponding to the light receiving element 225. Hereinafter, light from a predetermined incident direction incident on the light receiving element 225 is referred to as a light beam.

Description of Image Generating Unit 231a

The image generating unit 231a executes refocusing processing, which is a type of image processing, on the light receiving output of the image-capturing unit 22 configured as described above. The refocusing processing involves of generating an image at any image plane using the above-described light beam information (an intensity of light from a predetermined incident direction). An image at any image plane refers to an image at an image plane arbitrarily selected from a plurality of image planes set in the optical axis O direction of the image-capturing optical system 21.

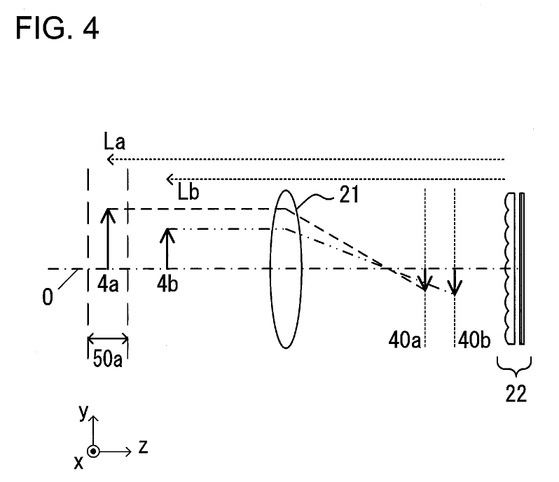

FIG. 4 is a view for explaining a principle of the refocusing processing. FIG. 4 schematically shows a subject 4a, a subject 4b, an image-capturing optical system 21, and an image-capturing unit 22 as viewed from a lateral direction (in X-axis direction).

An image of the subject 4a which is located away from the image-capturing unit 22 by a distance La is formed on an image plane 40a by the image-capturing optical system 21. An image of the subject 4b which is located away from the image-capturing unit 22 by a distance Lb is formed on an image plane 40b by the image-capturing optical system 21. In the following description, a plane on a subject side corresponding to an image plane is referred to as a subject plane. Additionally, a subject plane corresponding to an image plane selected as a target subjected to the refocusing processing may be referred to as a selected subject plane. For example, a subject plane corresponding to the image plane 40a is a plane on which the subject 4a is located.

The image generating unit 231a determines a plurality of light spots (pixels) on the image plane 40a in the refocusing processing. In a case where an image having 4000×3000 pixels is to be generated, for example, the image generating unit 231a determines 4000×3000 light spots. Light from a certain point of the subject 4a is incident on the image-capturing optical system 21 with a certain spread. The light passes through one light spot on the image plane 40a and is incident on one or more microlenses with a certain spread. The light is incident on one or more light receiving elements through the microlenses. For a given light spot determined on the image plane 40a, the image generating unit 231a specifies through which microlens and onto which light receiving elements the light beam having passed through the light spot is incident. The image generating unit 231a sets a sum of the light receiving outputs of the specified light receiving elements as a pixel value of the light spot. The image generating unit 231a executes the above processing for each light spot. The image generating unit 231a generates an image at the image plane 40a by such processing. The same applies to the image plane 40b.

The image at the image plane 40a generated by the processing described above is an image that can be considered as being focused (in focus) within a range of the depth of field 50a. Note that an actual depth of field is shallow on the front side (the side of the image-capturing optical system 21) and deep on the rear side; however, the depth of field in FIG. 4 has the same depths both on the front and rear sides, for the sake of simplicity. The same applies to the following description and figures. The image processing unit 23 calculates the depth of field 50a of the image generated by the image generating unit 231a based on a focal length of the image-capturing optical system 21, an aperture value (F value) of the image-capturing optical system 21, a distance La (photographing distance) to the subject 40a, a permissible circle of confusion of the image-capturing unit 22, and the like. Note that the photographing distance can be calculated from an output signal of the image-capturing unit 22 by a known method. For example, a distance to a subject of interest may be measured using a light receiving signal output by the image-capturing unit 22; a distance to the subject may be measured by a method such as a pupil split phase difference scheme or a ToF scheme; or a sensor for measuring the photographing distance may be separately provided in the image-capturing apparatus 2 so that an output of the sensor may be used.

Description of Image Synthesizing Unit 231b

The image generated by the image generating unit 231a can be considered as being in focus on a subject image located within a predetermined range (focal depth) in front of and behind the selected image plane. In other words, the image can be considered as being in focus on a subject located within a certain range (depth of field) before and after the selected subject plane. An image of a subject located outside the range may be in a lower-sharpness state (so-called blurred state, out-of-focus state), with respect to a subject located within the range.

The depth of field becomes shallower as the focal length of the image-capturing optical system 21 is longer, while it becomes deeper as the focal length is shorter. That is, in a case where an image of the monitor target 4 is captured at telephoto, the depth of field is shallower compared with that in a case where the image of the monitor target 4 is captured at wide angle. The image synthesizing unit 231b synthesizes a plurality of images generated by the image generating unit 231a to generate a synthesized image having a wider focusing range (a deeper depth of field, a wider in-focus range) than that of each of the images before synthesis. As a result, even when the image-capturing optical system 21 is in the telephoto state, a sharp image having a wide in-focus range is displayed on the display apparatus 3.

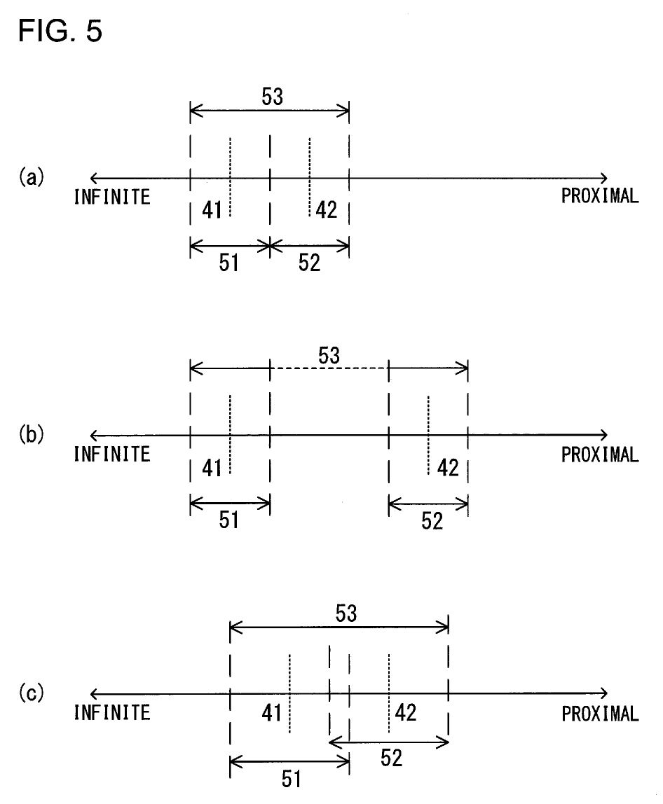

FIG. 5 is a view schematically showing a change in a focusing range by image synthesis. In FIG. 5, the right direction on the paper plane indicates a proximal direction and the left direction on the paper plane indicates an infinite direction. Now, it is assumed that the image generating unit 231a generates an image (first image) of a first subject plane 41 and an image (second image) of a second subject plane 42, as shown in FIG. 5(a). A depth of field of the first image is a first range 51 including the first subject plane 41. A depth of field of the second image is a second range 52 including the second subject plane 42. In a synthesized image generated by synthesizing the first image and the second image by the image synthesizing unit 231b, the first range 51 and the second range 52 constitute a focusing range 53. That is, the image synthesizing unit 231b generates a synthesized image having a focusing range 53 wider than those of the images to be synthesized.

The image synthesizing unit 231b can also synthesize more than two images. As the synthesized image is generated from a larger number of images, the focusing range of the synthesized image becomes wider. Note that although the first range 51 and the second range 52 illustrated in FIG. 5(a) are continuous ranges, focusing ranges of images to be synthesized may be discontinuous as shown in FIG. 5(b) or may partially overlap each other as shown in FIG. 5(c).

An example of the image synthesis processing by the image synthesizing unit 231b will be described. The image synthesizing unit 231b calculates a contrast value for each pixel of the first image. The contrast value is a numerical value representing a level of sharpness, which is an integrated value of absolute values of differences between a pixel value of a given pixel and pixel values of surrounding eight pixels (or four pixels that are adjacent to the given pixel in up, down, right, and left directions), for example. The image synthesizing unit 231b similarly calculates a contrast value for each pixel of the second image.

The image synthesizing unit 231b compares a contrast value of each pixel in the first image with a contrast value of a pixel at the same position in the second image. The image synthesizing unit 231b adopts a pixel having the higher contrast value as a pixel at this position in the synthesized image. The above-described processing creates a synthesized image that is in focus in both the focusing range of the first image and the focusing range of the second image.

Note that the method of generating a synthesized image described above is merely an example, and a synthesized image may also be generated by other methods. For example, calculation of contrast values and adoption for a synthesized image may be performed not in units of pixels, but in units of blocks consisting of a plurality of pixels (for example, in units of blocks of 4 pixels×4 pixels). Additionally, subject detection may be performed, and calculation of contrast values and adoption for a synthesized image may be performed for each subject. That is, a synthesized image may be created by extracting sharp subjects (a subject included within the depth of field) from the first image and the second image and putting them into one image. Further, a distance from a sensor for measuring a photographing distance to a subject may be determined, and the synthesized image may be generated based on the distance. For example, a subject included from the nearest point to an end point of the second range 52 (or a start point of the first range) may be extracted from the second image, and a subject included from the end point of the second range 52 (or the start point of the first range) to an infinite point may be extracted from the first image to create a synthesized image. Any method may be used to generate a synthesized image, as long as the method can obtain a focusing range wider than those of the first image and the second image. The output unit 27 outputs either an image at a specific image plane generated by the image generating unit 231a or a synthesized image which is synthesized by the image synthesizing unit 231b on the display apparatus 3 at predetermined intervals.

Description of Overall Operation of Image-Capturing System 1

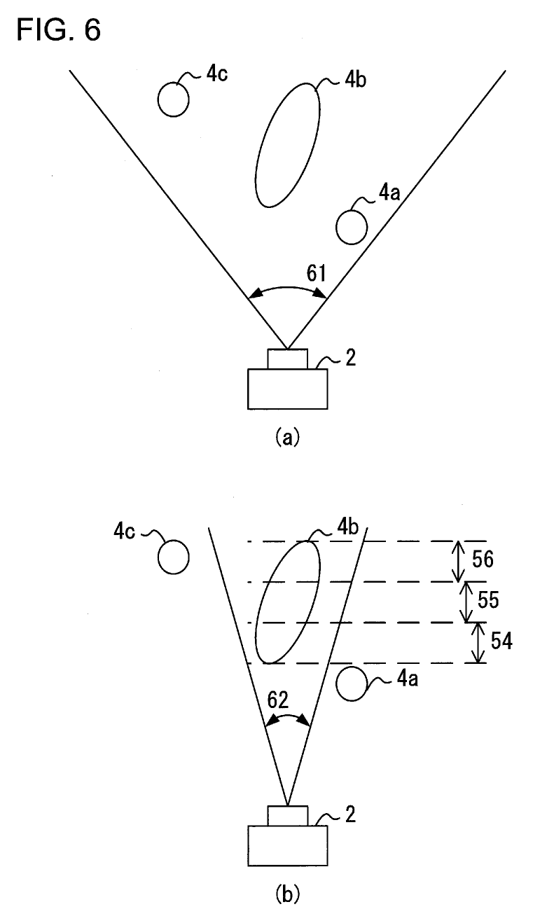

An overall operation of the image-capturing system 1 will be described below with reference to FIGS. 6 to 8.

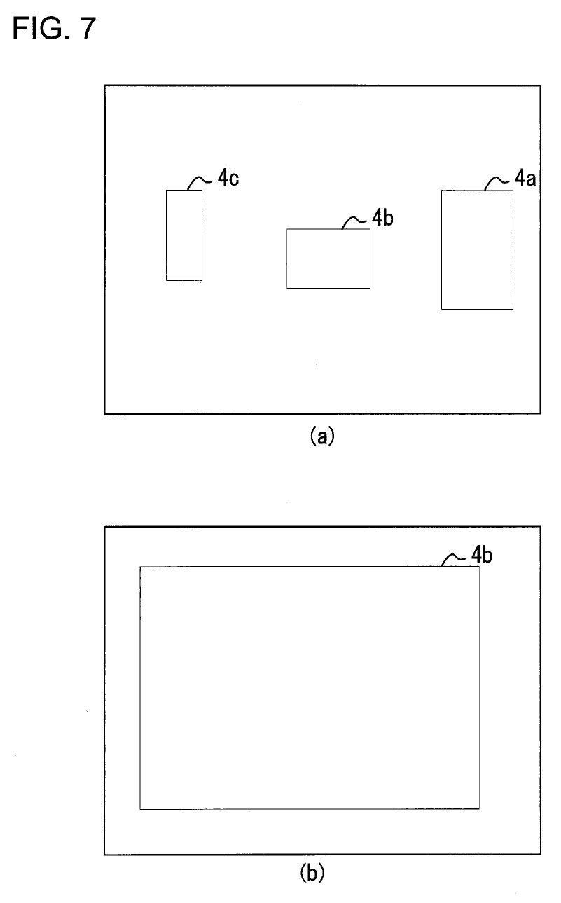

FIG. 6(a) is a top view schematically showing an angle of view 61 of the image-capturing apparatus 2 at a first focal length, and FIG. 6(b) is a top view schematically showing an angle of view 62 of the image-capturing apparatus 2 at a second focal length. The first focal length is shorter than the second focal length. That is, the first focal length is on a wide-angle side with respect to the second focal length, and the second focal length is on a telephoto side with respect to the first focal length. The display apparatus 3 displays an image (for example, FIG. 7(a)) having a relatively wide angle of view 61 on a display screen in the state shown in FIG. 6(a). The display apparatus 3 displays an image (for example, FIG. 7(b)) having a relatively narrow angle of view 62 on a display screen in the state shown in FIG. 6(b).

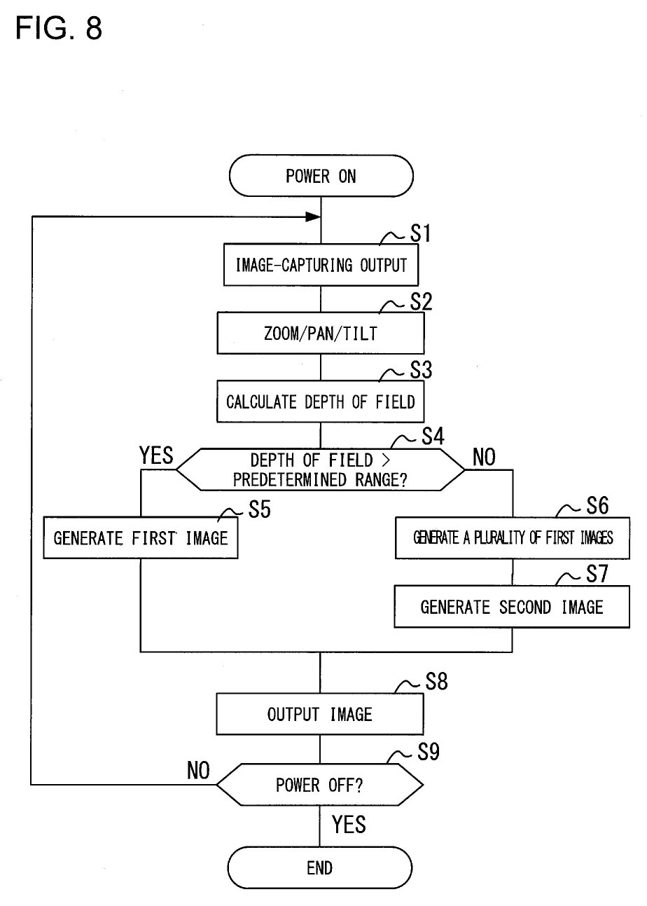

FIG. 8 is a flowchart showing an operation of the image-capturing apparatus 2.

In step S1, the control unit 26 of the image-capturing apparatus 2 controls the image-capturing optical system 21, the image-capturing unit 22, the image processing unit 23, the lens driving unit 24, the pan/tilt driving unit 25, and the like to capture an image of a range having a wide angle including a subject 4a, a subject 4b, and a subject 4c as in the state shown in FIG. 6(a). The control unit 26 controls the output unit 27 to output an image captured in a range having a wide angle to the display apparatus 3. The display apparatus 3 can display the image of FIG. 7(a).

For example, in step S2, an operator views the image displayed in the state of FIG. 6(a) and wants to confirm details of the subject 4b and therefore desires to display the subject 4b in an enlarged manner. The operator operates an operating member (not shown) to input an attention instruction (zoom instruction) of the subject 4b to the image-capturing apparatus 2 via the operating member (not shown). In the following description, the subject 4b selected by the operator here will be referred to as a subject of interest 4b (target object).

When an attention instruction (zoom instruction) is input, the control unit 26 outputs drive instructions to the lens driving unit 24 and the pan/tilt driving unit 25. In response to the drive instructions, the focal length of the image-capturing optical system 21 is changed from the first focal length to the second focal length, which is on the telephoto side, while the subject of interest 4b remains captured in the image-capturing screen. That is, the angle of view of the image-capturing optical system 21 changes from the state shown in FIG. 6(a) to the state shown in FIG. 6(b). On the display screen of the display apparatus 3, accordingly, the image shown in FIG. 7(a) is switched to the image shown in FIG. 7(b) so that the subject of interest 4b is displayed in an enlarged manner. The operator can observe the subject of interest 4b in detail. On the other hand, the depth of field (a range in which the image can be considered to be in focus) of the image generated by the image generating unit 231a is narrower as the focal length of the image-capturing optical system 21 changes to the telephoto side. That is, the depth of field is narrower in a case (FIG. 7(b)) where the subject of interest 4b is observed in the state shown in FIG. 6(b), compared with a case (FIG. 7(a)) where the subject of interest 4b is observed in the state shown in FIG. 6(a). As a result, some part of the subject of interest 4b is located within the depth of field, while other part of the subject of interest 4b is located outside the depth of field so that the image may be out of focus (blurred) in the part of the subject of interest 4b located outside the depth of field.

In step S3, the control unit 26 calculates the depth of field shown in FIG. 7(b). The calculation of the depth of field may be performed when either one of the focal length of the image-capturing optical system 21, the aperture value (F value) of the image-capturing optical system 21, and the distance La (photographing distance) to the subject 40a is changed. Alternatively, the depth of field of the image generated by the image generating unit 231a may be calculated at predetermined intervals (for example, 1/30 of one second).

In step S4, the control unit 26 determines whether the depth of field calculated in step S3 is larger or smaller than a predetermined range. If the control unit 26 determines that the depth of field is larger than the predetermined range, the process proceeds to step S5. If the control unit 26 determines that the depth of field is smaller than the predetermined range, the process proceeds to step S6.

In step S5, the control unit 26 controls the image processing unit 23 so that the image generating unit 231a generates one image (a first image) at the image plane. That is, if a calculated length of the depth of field in the optical axis direction is longer than a predetermined value (for example, 10 m), the first image is generated. The predetermined value may be a numerical value stored in advance in the storage unit or may be a numerical value input by the operator. The predetermined value may also be a numerical value determined by an orientation or size of the subject of interest 4b as described later. The predetermined image plane as used herein may be set, for example, in the vicinity of the center of a range to be synthesized when no subject of interest 4b is specified, so that a larger number of more subjects 4 may fall within the focusing range. Additionally, if the subject of interest 4b is specified, the predetermined image plane may be set, for example, in the vicinity of the center of the subject of interest 4b so that the subject of interest 4b falls within the focusing range. The image generating unit 231a may generate an image focused on one point within the depth of field. The one point within the depth of field may be one point in the subject of interest 4b.

In step S6, the control unit 26 controls the image processing unit 23 so that the image generating unit 231a generates images at a plurality of image planes (a plurality of first images). That is, if a calculated length of the depth of field in the optical axis direction is shorter than a predetermined value (for example, 10 m), a plurality of first images are generated. One of the plurality of first images is an image focused on one point within the depth of field. Additionally, another one of the plurality of first images is an image focused on one point outside the depth of field. The one point outside the depth of field may be one point included within the outside of the depth of field in the subject of interest 4b.

In step S7, the control unit 26 controls the image processing unit 23 so that the image synthesizing unit 231b synthesizes the plurality of images. As a result, the image synthesizing unit 231b generates a synthesis image (second image) having a deeper depth of field (a wider focusing range, a wider in-focus range) than the image (first image) generated by the image generating unit 231a. An image focused on one point within the depth of field and one point outside the depth of field is generated. The one point within the depth of field may be one point included within the depth of field in the subject of interest 4b. The one point outside the depth of field may be one point included within the outside of the depth of field in the subject of interest 4b.

In step S8, the control unit 26 controls the output unit 27 to output the image generated by the image generating unit 231a or the image generated by the image synthesizing unit 231b to the display apparatus 3.

In step S9, the control unit 26 determines whether a power switch (not shown) is operated to input a power-off instruction. If the power-off instruction is not input, the control unit 26 proceeds the process to step S1. On the other hand, if the power-off instruction is input, the control unit 26 ends the process shown in FIG. 8.

Note that the image generating unit 231a may generate the minimum number of images including the subject of interest 4b. For example, it is assumed that in the state illustrated in FIG. 6(b), the size (extent) of the subject of interest 4b in the optical axis O direction is approximately three times the depth of field of one image. The image generating unit 231a then generates an image having a first range 54 as its depth of field, an image having a second range 55 as its depth of field, and an image having a third range 56 as its depth of field. The first range 54 is a range including a front part of the subject of interest 4b, the second range 55 is a range including a center part of the subject of interest 4b, and the third range 56 is a range including a rear of the subject of interest 4b.

Note that the “predetermined range (predetermined value)” with which the image processing unit 23 here compares the depth of field may be determined in advance based on the size in the optical axis O direction of the subject of interest to be monitored by the image-capturing system 1. For example, provided that a ship having a total length of approximately 100 m is to be monitored by the image-capturing system 1, the predetermined range may be set to a range of 100 m. The image processing unit 23 can switch between generation of the first image or generation of the second image, depending on whether the depth of field exceeds 100 m.

Effects of the operation of the image-capturing system 1 described above will be described. When the subject of interest 4b is zoomed up, the image displayed by the display apparatus 3 becomes an image having a relatively shallow depth of field. Therefore, depending on the size of the subject of interest 4b in the depth direction (the optical axis O direction of the image-capturing optical system 21), not the overall subject of interest 4b may fall within the depth of field in the image generated by the image generating unit 231a. For example, in a case where the subject of interest 4b is a large ship and is anchored in parallel to the optical axis O, an image is displayed in which only a part (for example, a center part) of its hull is in focus and the rest of the hull (for example, a bow and a stern) is blurred.

The image generating unit 231a hence generates a plurality of images that are in focus on their corresponding parts of the hull and the image synthesizing unit 231b then synthesizes the plurality of images, so that the synthesized image becomes an image that is in focus on the entire hull. That is, the image synthesizing unit 231b can synthesize the plurality of images generated by the image generating unit 231a to generate a synthesized image having a depth of field deeper than those of the plurality of images and including the entire subject of interest 4b within the depth of field.

The generation of such a synthesized image requires an amount of calculation than larger that for the generation of one image by the image generating unit 231a. Specifically, the image generating unit 231a has to generate a larger number of images. Additionally, a synthesis processing by the image synthesizing unit 231b is required. Therefore, if the display apparatus 3 constantly displays the synthesized image by the image synthesizing unit 231b, problems such as a decrease in frame rate and a delay in display may occur.

In an example of the present embodiment, the image synthesizing unit 231b may generate a synthesized image only when a depth of field becomes less than or equal to a predetermined range. Furthermore, the image generating unit 231a may generate only the minimum required number of images. Therefore, the subject of interest 4b to be monitored can be effectively observed with a smaller amount of calculation, compared with the method described above. The reduced amount of calculation less likely causes problems such as a delay in display of the display apparatus 3 and a reduction in frame rate.

Note that the image generating unit 231a may not necessarily generate a plurality of images so as to include the entire subject of interest 4b. For example, in the state of FIG. 6(b), the image generating unit 231a may generate an image having the first range 54 as its depth of field and an image having the third range 56 as its depth of field. Even in this case, an image synthesized by the image synthesizing unit 231b has a depth of field deeper than that in a case of one single image, so that the subject of interest 4b to be monitored can be effectively observed.

According to the embodiment described above, the following operations and effects can be achieved.

(1) The image-capturing unit 22 includes a plurality of light receiving element groups 224 each including a plurality of light receiving elements 225, receives light having passed through the image-capturing optical system 21, which is an optical system having a variable power function, and the microlens 223 respectively at the light receiving element groups 224, and outputs a signal based on the received light. Based on the signal output by the image-capturing unit 22, the image processing unit 23 generates an image focused on one point of at least one subject among a plurality of objects located at different positions in the optical axis O direction. If a length of a range in the optical axis O direction specified by a focal length in a case where the image-capturing optical system 21 focuses on one point of a target object (subject of interest) is larger than a length based on the target object, the image processing unit 23 generates a first image focused on one point within the range. If the length of the range is smaller than the length based on the target object, the image processing unit 23 generates a second image focused on one point outside the range and one point within the range. This can provide an image-capturing apparatus suitable for monitoring a subject of interest, the apparatus displaying an image that is in focus on the entire subject of interest. Additionally, only the minimum necessary image synthesis is performed so that a monitored image can be displayed with limited calculation resource and power consumption and without delay.

(2) A length based on a target object refers to a length based on an orientation or size of a target object, which is a length of a target object in the optical axis O direction, for example. This can provide an image that is in focus on at least the entire subject of interest.

(3) The range described above is a range having a length that is shortened when the focal length is changed by the variable power function of the image-capturing optical system 21. If the focal length is changed and the length of the range is shortened so as to be smaller than the length based on the target object, the image processing unit 23 generates the second image. Thus, depending on the situation, the image is displayed without performing the synthesis processing, so that a monitored image can be displayed with limited calculation resource and power consumption and without delay.

(4) The image processing unit 23 generates the second image focused on one point of the target object located outside the range described above and one point within the range. This enables displaying an image that is in focus on a wider range and is suitable for monitoring.

(5) The image processing unit 23 generates the second image focused on one point of the target object located outside the range described above and one point within the range. This enables displaying an image that is in focus on a wider range and is suitable for monitoring.

(6) The range described above is a range based on the focal length changed by the variable power function of the image-capturing optical system 21. The range is, for example, a range based on the depth of field. This enables displaying an image optimal for monitoring following zoom-in and zoom-out operations.

(7) The image processing unit 23 generates a second image having an in-focus range wider than the in-focus range in the first image. This enables displaying an image that is in focus on a wider range and is suitable for monitoring.

The image processing unit 23 described above compares a predetermined range set in advance in accordance with an assumed subject with the depth of field, and switches an image to be generated in accordance with the comparison result. Alternatively, a plurality of predetermined ranges may be set in advance so that a predetermined range used for control can be switched in accordance with an instruction of the operator. For example, the image processing unit 23 may use a first predetermined range corresponding to a large vessel and a second predetermined range corresponding to a small vessel by switching between them in accordance with an instruction of the operator. For example, the image processing unit 23 may set a value input by the operator using an input apparatus such as a keyboard as the predetermined range described above and compare the value with the depth of field.

The image processing unit 23 described above causes the image synthesizing unit 231b to generate a synthesized image having a depth of field just including an entire subject of interest (target object). The image processing unit 23 may cause the image synthesizing unit 231b to generate a synthesized image having a depth of field including a wider range. For example, the image processing unit 23b may cause the image synthesizing unit 231b to generate a synthesized image so that a depth of field of an image generated by the image synthesizing unit 231b is deeper as a depth of field in one image generated by the image generating unit 231a is shallower. That is, the image processing unit 23 may cause the image synthesizing unit 231b to synthesize a larger number of images as a depth of field in one image generated by the image generating unit 231a is shallower.

In the example described above, the image processing unit 23 described above includes the image generating unit 231a and the image synthesizing unit 231b, and the image synthesizing unit 231b synthesizes a plurality of images generated by the image generating unit 231a to generate the second image. However, the way of generating the second image is not intended to this. For example, the second image may be generated directly from an output of the image-capturing unit 22. In this case, the image synthesizing unit 231b may be omitted.

### Second Embodiment

The image-capturing apparatus 2 according to the first embodiment compares a predetermined range determined in advance with the depth of field. An image-capturing apparatus 1002 according to a second embodiment detects a size (length) of a subject of interest (target object) in a depth direction (optical axis direction), and compares a predetermined range (predetermined value) according to the size with a depth of field. That is, the image-capturing apparatus 1002 according to the second embodiment automatically determines a predetermined range (predetermined value) to be compared with the depth of field according to the size of the subject of interest. The size of the subject of interest is not limited to the length in the depth direction, but may include the orientation and size of the subject of interest.

FIG. 7 is a block diagram schematically showing a configuration of the image-capturing apparatus 1002 according to the second embodiment. Hereinafter, differences from the image-capturing apparatus 2 (FIG. 2) according to the first embodiment will be mainly described, and descriptions of parts similar to those of the first embodiment will be omitted.

The image-capturing apparatus 1002 includes a control unit 1026 that replaces the control unit 26 (FIG. 2), an image processing unit 1231 that replaces the image processing unit 23, and a detection unit 1232. The detection unit 1232 performs image recognition processing on an image generated by the image generating unit 231a to detect a size of a subject of interest in the optical axis O direction. Alternatively, a size of a subject of interest in the optical axis O direction may be detected by a laser, a radar, or the like.

The image processing unit 1231 calculates the depth of field when either one of the focal length of the image-capturing optical system 21, the aperture value (F value) of the image-capturing optical system 21, and the distance La (photographing distance) to the subject 40a is changed. Alternatively, the depth of field of the image generated by the image generating unit 231a may be calculated at predetermined intervals (for example, 1/30 of one second). The image processing unit 1231 causes the image generating unit 231a to generate an image at one image plane. The detection unit 1232 detects the type of the subject of interest by executing known image processing such as template matching on the image generated by the image generating unit 231a. For example, the detection unit 1232 detects whether the subject of interest is a large vessel, a medium vessel, or a small vessel. The detection unit 1232 notifies the image processing unit 1231 of a different size according to the detection result, as the size of the subject of interest. The image processing unit 1231 stores different predetermined ranges (predetermined values) depending on the notified sizes. The image processing unit 1231 compares the predetermined range corresponding to the notified size with the calculated depth of field. If the calculated depth of field is larger than the predetermined range, the image processing unit 1231 causes the image generating unit 231a to generate an image (first image) at one image plane. The output unit 27 outputs the generated first image to the display apparatus 3.

If the calculated depth of field is equal to or less than the predetermined range, the image processing unit 1231 causes the image generating unit 231a to generate images at further one or more image planes. The image processing unit 1231 causes the image synthesizing unit 231b to synthesize the previously generated image at one image plane and the further generated images at one or more image planes. As a result, the image synthesizing unit 231b generates a synthesis image (second image) having a deeper depth of field (a wider focusing range) than the image (first image) generated by the image generating unit 231a. The output unit 27 outputs a synthesized image which is synthesized by the image synthesizing unit 231b on the display apparatus 3. Other operations of the image-capturing apparatus 2 may be the same as in the first embodiment (FIG. 8).

According to the embodiment described above, the following operations and effects can be achieved in addition to the operations and effects of the first embodiment.

(8) The detection unit 1232 detects the orientation or size of the target object. The image processing unit 1231 generates a first image or a second image based on a length based on the target object which is changed according to the orientation or size of the target object detected by the detection unit 1232. This can provide an image that is in focus on the entire subject of interest.

(9) The detection unit 1232 detects the orientation or size of the target object based on the image generated by the image processing unit 1231. This can provide a flexible apparatus capable of properly dealing with various types of subject of interests.

The detection unit 1232 described above detects the size in the depth direction (the optical axis O direction) of the subject of interest by subject recognition processing, which is a type of image processing. The method of detecting the size by the detection unit 1232 is not limited to image processing.

For example, the detection unit 1232 may detect the size in the depth direction (the optical axis O direction) of a subject of interest by measuring a distance to the subject of interest using a light receiving signal output by the image-capturing unit 22. For example, the detection unit 1232 measures a distance of each part of the subject of interest and detects a difference between the distance to the nearest part and the distance to the farthest part as a size in the depth direction (optical axis O direction) of the subject of interest.

For example, the detection unit 1232 has a sensor for measuring a distance by a known method such as a pupil split phase difference scheme or a ToF scheme. For example, the detection unit 1232 uses the sensor to measure a distance of each part of the subject of interest and detect a difference between the distance to the nearest part and the distance to the farthest part as a size in the depth direction (optical axis O direction) of the subject of interest.

For example, the detection unit 1232 has a sensor for detecting the size in the depth direction (the optical axis O direction) of the subject of interest by a method different from the method described above. For example, the detection unit 1232 uses the sensor to detect a size in the depth direction (optical axis O direction) of the subject of interest. Specific examples of the sensor include an image sensor for capturing an image of a subject of interest such as a ship, and a sensor having a communication unit that extracts an identification number, a name, and the like written on a hull from a captured image and inquires of an external server and the like about the size of a ship corresponding to the identification number and the like, via a network. In this case, for example, the size of the ship can be extracted from the Internet, based on the ship identification number or name written on the ship.

### Third Embodiment

The image-capturing apparatus 2 according to the first embodiment or the image-capturing apparatus 1002 according to the second embodiment compares the predetermined range with the depth of field and generates the first image or the second image based on the comparison result. An image-capturing apparatus 102 according to a third embodiment determines whether a subject of interest (target object) is included within a depth of field, and generates a first image or a second image based on the determination result. Hereinafter, differences from the image-capturing apparatus 2 (FIG. 2) according to the first embodiment will be mainly described, and descriptions of parts similar to those of the first embodiment will be omitted.

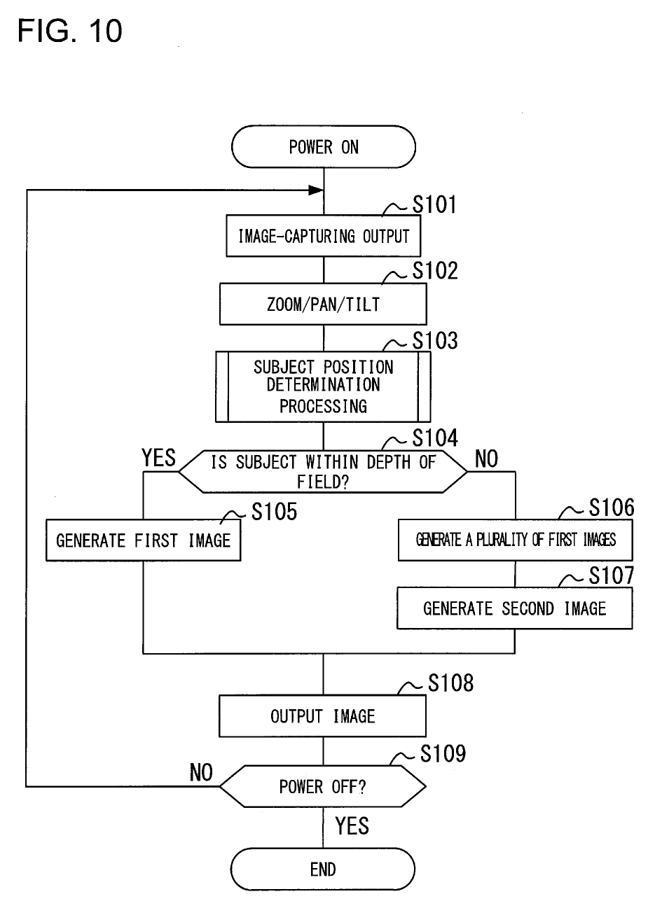

An operation of the image-capturing apparatus 102 will be described using a flowchart shown in FIG. 10. In step S1, the control unit 26 of the image-capturing apparatus 2 controls the image-capturing optical system 21, the image-capturing unit 22, the image processing unit 23, the lens driving unit 24, the pan/tilt driving unit 25, and the like to capture an image of a range having a wide angle including a subject 4a, a subject 4b, and a subject 4c as in the state shown in FIG. 6(a). The control unit 26 controls the output unit 27 to output an image captured in a range having a wide angle to the display apparatus 3. The display apparatus 3 can display the image of FIG. 7(a).

For example, in step S2, an operator views the image displayed in the state of FIG. 6(a) and wants to confirm details of the subject 4b and therefore desires to display the subject 4b in an enlarged manner. The operator operates an operating member (not shown) to input an attention instruction (zoom instruction) of the subject 4b to the image-capturing apparatus 2 via the operating member (not shown). In the following description, the subject 4b selected by the operator here will be referred to as a subject of interest 4b (target object).

When an attention instruction (zoom instruction) is input, the control unit 26 outputs drive instructions to the lens driving unit 24 and the pan/tilt driving unit 25. In response to the drive instructions, the focal length of the image-capturing optical system 21 is changed from the first focal length to the second focal length, which is on the telephoto side, while the subject of interest 4b remains captured in the image-capturing screen. That is, the angle of view of the image-capturing optical system 21 changes from the state shown in FIG. 6(a) to the state shown in FIG. 6(b). On the display screen of the display apparatus 3, accordingly, the image shown in FIG. 7(a) is switched to the image shown in FIG. 7(b) so that the subject of interest 4b is displayed in an enlarged manner. The operator can observe the subject of interest 4b in detail. On the other hand, the depth of field (a range in which the image can be considered to be in focus) of the image generated by the image generating unit 231a is narrower as the focal length of the image-capturing optical system 21 changes to the telephoto side. That is, the depth of field is narrower in a case (FIG. 7(b)) where the subject of interest 4b is observed in the state shown in FIG. 6(b), compared with a case (FIG. 7(a)) where the subject of interest 4b is observed in the state shown in FIG. 6(a). As a result, some part of the subject of interest 4b is located within the depth of field, while other part of the subject of interest 4b is located outside the depth of field so that the image may be out of focus (blurred) in the part of the subject of interest 4b located outside the depth of field.

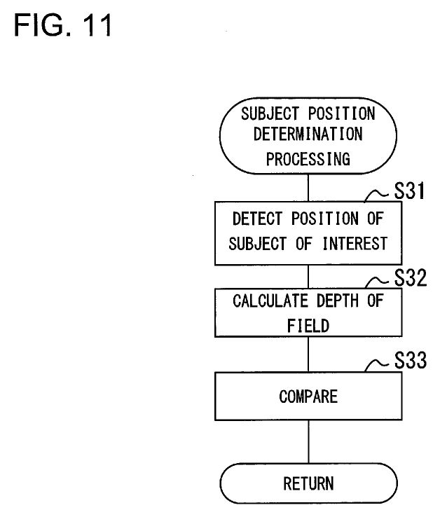

In step S103, the control unit 26 executes subject position determination processing for detecting a positional relationship between the position of the subject of interest 4b and the position of the depth of field. A method of detecting the positional relationship by the subject position determination processing will be described in detail later with respect to FIG. 11.

In step S104, if it is determined that the depth of field includes the entire subject of interest 4b as a result of the subject position determination processing executed in step S103, the control unit 26 proceeds the process to step S105. If it is determined that at least a part of the subject of interest 4b is included within the outside of the depth of field, the control unit 26 proceeds the process to step S106.

In step S105, the control unit 26 controls the image processing unit 23 so that the image generating unit 231a generates one image (a first image) at the image plane. That is, if a calculated length of the depth of field in the optical axis direction is longer than a predetermined value (for example, 10 m), the first image is generated. The predetermined value may be a numerical value stored in advance in the storage unit or may be a numerical value input by the operator. The predetermined value may also be a numerical value determined by an orientation or size of the subject of interest 4b as described later. The predetermined image plane as used herein may be set, for example, in the vicinity of the center of a range to be synthesized when any subject of interest 4b is not specified, so that a larger number of subjects 4 may fall within the focusing range. Additionally, if the subject of interest 4b is specified, the predetermined image plane may be set, for example, in the vicinity of the center of the subject of interest 4b so that the subject of interest 4b falls within the focusing range. The image generating unit 231a may generate an image focused on one point within the depth of field. The one point within the depth of field may be one point in the subject of interest 4b.

In step S106, the control unit 26 controls the image processing unit 23 so that the image generating unit 231a generates images at a plurality of image plane (a plurality of first images). That is, if a calculated length of the depth of field in the optical axis direction is shorter than a predetermined value (for example, 10 m), a plurality of first images are generated. One of the plurality of first images is an image focused on one point within the depth of field. Additionally, another one of the plurality of first images is an image focused on one point outside the depth of field. The one point outside the depth of field may be one point included within the outside of the depth of field in the subject of interest 4b.

In step S107, the control unit 26 controls the image processing unit 23 so that the image synthesizing unit 231b synthesizes the plurality of images. As a result, the image synthesizing unit 231b generates a synthesis image (second image) having a deeper depth of field (a wider focusing range, a wider in-focus range) than the image (first image) generated by the image generating unit 231a. An image focused on one point within the depth of field and one point outside the depth of field is generated. The one point within the depth of field may be one point included within the depth of field in the subject of interest 4b. The one point outside the depth of field may be one point included within the outside of the depth of field in the subject of interest 4b.

In step S108, the control unit 26 controls the output unit 27 to output the image generated by the image generating unit 231a or the image generated by the image synthesizing unit 231b to the display apparatus 3.

In step S109, the control unit 26 determines whether a power switch (not shown) is operated to input a power-off instruction. If the power-off instruction is not input, the control unit 26 proceeds the process to step S1. On the other hand, if the power-off instruction is input, the control unit 26 ends the process shown in FIG. 8.

The subject position determination processing executed in step S103 of FIG. 10 will be described in detail using the flowchart shown in FIG. 11.

In step S31, the control unit 26 detects the position of the subject of interest 4b. The method of detecting the position of the subject of interest 4b may be the method described above in the first embodiment or the second embodiment.

In step S32, the control unit 26 calculates the depth of field. The calculated depth of field has a front-side depth of field and a rear-side depth of field with reference to one point (a point that can be considered as being in focus) of the subject of interest 4b.

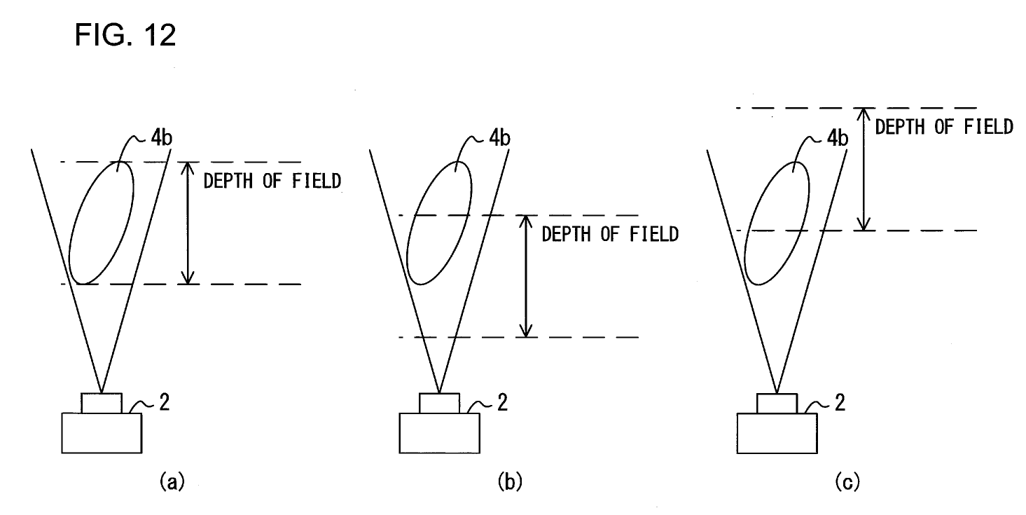

In step S33, the control unit 26 compares the position of the subject of interest 4b detected in step S31 with the position of the depth of field calculated in step S32. The control unit 26 determines whether the subject of interest 4b is included within the depth of field by comparing both positions. The control unit 26 compares, for example, the distance to the forward end of the subject of interest 4b and the distance to the forward end of the depth of field. If the distance to the forward end of the subject of interest 4b is shorter than the distance to the forward end of the depth of field, that is, the forward end of the subject of interest 4b is not included within the depth of field and beyond the forward end thereof, the control unit 26 determines that the subject of interest 4b is not included within the depth of field. Similarly, the control unit 26 compares, for example, the distance to the rearward end of the subject of interest 4b and the distance to the rearward end of the depth of field. If the distance to the rearward end of the subject of interest 4b is longer than the distance to the rearward end of the depth of field, that is, the rearward end of the subject of interest 4b is not included within the depth of field and beyond the rearward end thereof, the control unit 26 determines that the subject of interest 4b is not included within the depth of field. As a result of comparison, the control unit 26 determines whether the subject of interest 4b is included within the depth of field as shown in FIG. 12(a) or a part of the subject of interest 4b is included within the outside of the depth of field as shown in FIGS. 12(b), 12(c). In the state shown in FIG. 12(a), the entire subject of interest 4b is included within the depth of field. Thus, it can be considered that the entire subject of interest 4b is in focus (not blurred). In the states shown in FIGS. 12(b), 12(c), at least a part of subject of interest 4b is not included within the depth of field. Thus, it can be considered that the part of the subject of interest 4b not included within the depth of filed is out-of-focus (blurred). In other words, it can be considered that the part of the subject of interest 4b included within the outside of the depth of filed is out-of-focus (not blurred). If it is determined in the subject position determination processing that the actual state is the state shown in FIG. 12(a), in step S104 of FIG. 10, the control unit 26 proceeds the process to step S105. If it is determined in the subject position determination processing that the actual state is the state shown in FIG. 12(b) or FIG. 12(c), in step S104 of FIG. 10, the control unit 26 proceeds the process to step S106.

According to the embodiment described above, the same operations and effects as those in the first embodiment can be achieved.

Although various embodiments and modifications have been described above, the present invention is not limited to these. Other aspects contemplated within the scope of the technical idea of the present invention are also included within the scope of the present invention. It is not necessary to include all of the above-described components. Any combination may be used. Moreover, not only the above-described embodiment but any combinations may be used.

The disclosure of the following priority application is herein incorporated by reference:

Japanese Patent Application No. 2016-192253 (filed on Sep. 29, 2016)

### REFERENCE SIGNS LIST

1 . . . image-capturing system, 2 . . . image-capturing apparatus, 3 . . . display apparatus, 21 . . . image-capturing optical system, 22 . . . image-capturing unit, 23, 1231 . . . image processing unit, 24 . . . lens driving unit, 25 . . . pan/tilt driving unit, 1026, 26 . . . control unit, 27 . . . output unit, 221 . . . micro lens array, 222 . . . light receiving element array, 223 . . . microlens, 224 . . . light receiving element group, 225 . . . light receiving element, 231a . . . image generating unit, 231b . . . image synthesizing unit, 1232 . . . detection unit

1. An image-capturing apparatus, comprising:
an optical system;
a plurality of microlenses;
an image sensor having a plurality of pixel groups each including a plurality of pixels, receiving light having passed through the optical system and the microlenses respectively at the pixel groups, and outputting a signal based on the received light; and
an image processing unit that generates a first image data in which an image is focused on a first range in an optical axis direction, based on the signal output by the image sensor, wherein:
the image processing unit is capable of generating a second image data in which an image is focused on a second range including the first range and being larger than the first range.

2. The image-capturing apparatus according to claim 1, wherein:
the image processing unit generates the second image data, in which an image is focused on the second range, based on a size of an object in the optical axis direction, at least a part of the object being included within the first range.

3. The image-capturing apparatus according to claim 2, wherein:
while the first range is smaller than the size of the object in the optical axis direction, the image processing unit generates the second image data in which an image is focused on the second range which is larger than the size of the object in the optical axis direction.

4. The image-capturing apparatus according to claim 2, wherein:
while at least a part of the object is included within the outside of the first range in the optical axis direction, the image processing unit generates the second image data in which an image is focused on the second range including the object.

5. The image-capturing apparatus according to claim 2, wherein:
while a focal length of the optical system is changed for zooming, the image processing unit generates the second image data in which an image is focused on the second range.

6. The image-capturing apparatus according to claim 2, wherein:
while at least a part of the object is included within the outside of the first range after changing a focal length of the optical system, the image processing unit generates the second image data in which an image is focused on the second range.

7. An image-capturing apparatus, comprising:
an optical system having a variable power function;
a plurality of microlenses;
an image sensor having a plurality of pixel groups each including a plurality of pixels, receiving light having passed through the optical system and the microlenses respectively at the pixel groups, and outputting a signal based on the received light; and
an image processing unit that generates an image focused on one point of at least one object among a plurality of objects located at different positions in an optical axis of the optical system, based on the signal output by the image sensor, wherein:
if the entire target object is included within the range in the optical axis direction specified by the focal length in a case where the optical system focuses on one point of the target object, the image processing unit generates a first image focused on one point within the range, and if at least a part of the target object is included within the outside of the range, the image processing unit generates a second image focused on one point outside the range and one point within the range.

8. The image-capturing apparatus according to claim 7, wherein:
the range is a range having a length that is shortened when the focal length is changed by the variable power function of the optical system; and
the image processing unit generates the second image when the focal length is changed to narrow the range and at least a part of the target object is included within the outside of the range.

9. The image-capturing apparatus according to claim 7, wherein:
the image processing unit generates the second image focused on one point of the target object included within the outside of the range and one point within the range.

10. The image-capturing apparatus according to claim 9, wherein:
the image processing unit generates the second image focused on one point of the target object included within the outside of the range and one point of the target object included within the range.

11. The image-capturing apparatus according to claim 7, wherein:
the range is a range based on the focal length which is changed by the variable power function of the optical system.

12. The image-capturing apparatus according to claim 11, wherein:
the range is a range based on the depth of field.

13. The image-capturing apparatus according to claim 7, wherein:
the image processing unit generates the second image focused on a range wider than a focusing range in the first image.

14. An image-capturing apparatus, comprising:
an optical system having a variable power function;
a plurality of microlenses;
an image sensor having a plurality of pixel groups each including a plurality of pixels, receiving light having passed through the optical system and the microlenses, and outputting a signal based on the received light; and
an image processing unit that generates an image focused on one point of at least one object among a plurality of objects located at different positions in an optical axis of the optical system, based on the signal output by the image sensor, wherein:
if the target object is located within the depth of field, the image processing unit generates a first image focused on one point within the depth of field, and if a part of the target object is outside the depth of field, the image processing unit generates a second image focused on one point of the target object located outside the depth of field and one point of the target object located within the depth of field.

15. An image-capturing apparatus, comprising:
an optical system having a variable power function;
a plurality of microlenses;
an image sensor having a plurality of pixel groups each including a plurality of pixels, receiving light having passed through the optical system and the microlenses respectively at the pixel groups, and outputting a signal based on the received light; and
an image processing unit that generates an image focused on one point of at least one object among a plurality of objects located at different positions in an optical axis of the optical system, based on the signal output by the image sensor, wherein:
if it is determined that the entire target object is in focus, the image processing unit generates a first image that is determined to be in focus on the target object, and if it is determined that a part of the target object is out of focus, the image processing unit generates a second image that is determined to be in focus on the entire target object.

16. An image-capturing apparatus, comprising:
an optical system;
a plurality of microlenses;
an image sensor having a plurality of pixel groups each including a plurality of pixels, receiving light having originated from a subject and having passed through the optical system and the microlenses respectively at the pixel groups, and outputting a signal based on the received light; and
an image processing unit that generates image data based on the signal output from the image sensor, wherein:
if it is determined that one end or another end of the subject in the optical axis direction is not included within the depth of field, the image processing unit generates third image data based on first image data having the one end included within a depth of field thereof and second image data having the other end included within a depth of field thereof.

17. The image-capturing apparatus according to claim 16, wherein:
the third image data is image data that appears to be in focus on the one end and the other end.

18. The image-capturing apparatus according to claim 16, wherein:
the third image data has a range that appears to be in focus, the range varying depending on a size of the subject in the optical axis direction.

19. The image-capturing apparatus according to claim 16, wherein:
the image processing unit generates the third image data based on a size of the subject in the optical axis direction.
